(19) United States
(12) Patent Application Publication
(10) Pub. No.: US 2025/0283302 A1
(43) Pub. Date: Sep. 11, 2025

(54) INTELLIGENT CONTROL SYSTEM FOR ENGINEERING MACHINE

(71) Applicant: HANGZHOU CITY UNIVERSITY, Hangzhou (CN)

(72) Inventors: Zheshuo ZHANG, Hangzhou (CN); Liping YANG, Hangzhou (CN); Wenwei MO, Hangzhou (CN); Bing RAO, Hangzhou (CN)

(21) Appl. No.: 19/217,338

(22) Filed: May 23, 2025

Related U.S. Application Data
(63) Continuation of application No. PCT/CN2023/102534, filed on Jun. 26, 2023.

(30) Foreign Application Priority Data
Nov. 23, 2022 (CN) 2022114711130

(51) Int. Cl. E02F 9/20; E01C 19/00; E02F 9/24; E02F 9/26

(52) U.S. Cl. CPC E02F 9/2045; E01C 19/004; E02F 9/2054; E02F 9/24; E02F 9/26

(57) ABSTRACT

Provided is an intelligent control system for an engineering machine, which relates to the technical field of data analysis. The intelligent control system includes a server and an on-board terminal. The on-board terminal includes an image collection module, a main control module, a communication module, and a display module. The intelligent control system for the engineering machine can improve the safety of the engineering machine during movement.

### CROSS-REFERENCE TO RELATED APPLICATIONS

This application is a continuation of PCT/CN2023/102534, with a filing date of Jun. 26, 2023, and claims to the benefit of priority from Chinese Application No. 202211471113.0 with a filing date of Nov. 23, 2022. The content of the aforementioned applications, including any intervening amendments thereto, are incorporated herein by reference.

### TECHNICAL FIELD

The present disclosure relates to the technical field of data analysis, and more particularly, to an intelligent control system for an engineering machine.

### BACKGROUND

With the rapid development of society, an engineering machine is widely used in the fields of construction, transportation, agriculture, forestry, and water conservancy due to its high efficiency and performance that cannot be realized by a manual labor in infrastructure construction. The engineering machine mainly includes an excavator, a loader, a road roller, and the like.

Due to the harsh working environment of the engineering machine, for example, rugged roads and large blind spots, it is easy to collide with people or obstacles around and cause safety accidents. In order to avoid the above problem, the engineering machine is gradually developing in a direction of intelligence. For example, an ultrasonic radar or a camera is installed on the engineering machine to detect surrounding environment of the engineering machine, and an operators is assisted in controlling the engineering machine based on environmental information to reduce the operation difficulty of the operator.

However, the construction site environment is complex and prone to conditions such as high dust levels and contamination of the camera lens. These factors can lead to reduced image clarity and decreased recognizability, thereby increasing the difficulty of obtaining information about the surrounding environment. Especially when the engineering machine needs to move, the information obtained is reduced, which easily affects the judgment of the operator.

Therefore, there is a need for an intelligent control system for the engineering machine that can improve the safety of the engineering machine during movement.

### SUMMARY

The present disclosure provides an intelligent control system for an engineering machine, which can improve the safety of the engineering machine during movement.

In order to solve the technical problem described above, the present disclosure provides the following technical solution.

An intelligent control system for an engineering machine is provided. The intelligent control system includes a server and an on-board terminal disposed on the engineering machine. The on-board terminal includes an image collection module, an internal data obtaining module, a satellite positioning module, a main control module, a communication module, and a display module.

The satellite positioning module is configured to obtain current position data of the engineering machine.

The communication module is configured to transmit the position data to the server in real time.

The server is configured to generate a movement trajectory of each engineering machine based on the position data uploaded by each engineering machine. The movement trajectory includes a movement route of each engineering machine and a movement speed of each engineering machine at each position on the movement route.

The image collection module is configured to collect image data outside the engineering machine.

The internal data obtaining module is configured to obtain state data of the engineering machine.

The main control module is configured to analyze the image data to determine whether clarity of the image data meets a predetermined requirement, when the predetermined requirement is not met, determine whether the engineering machine is currently in a moving state based on the state data, and when the engineering machine is currently in the moving state, transmit an auxiliary request to the server through the communication module.

The server is further configured to, subsequent to receiving the auxiliary request, estimate a future movement route of the engineering machine based on a current movement route of the engineering machine and an existing movement route of another engineering machine, match road sections of the estimated movement route of the engineering machine with corresponding road sections of the existing movement route of the other engineering machine based on the estimated movement route, and calculate an average movement speed of the engineering machine at each position on a successfully matched road section as an average movement speed of the engineering machine at each position on the estimated movement route; and transmit the estimated movement route of the engineering machine and the average movement speed of the engineering machine at each position on the estimated movement route to the main control module through the communication module.

The main control module is further configured to determine whether a current position of the engineering machine is on the estimated movement route, when the current position of the engineering machine is on the estimated movement route, calculate a difference value between a current movement speed of the engineering machine and an average movement speed of the engineering machine at a corresponding position on the estimated movement route, determine whether the difference value is greater than a first threshold value, and generate alarm information when the difference value is greater than the first threshold value.

The display module is configured to display the image data and the alarm information.

The principle and beneficial effect of the basic solution are as follows.

The present solution involves collecting the image data outside the engineering machine and displaying it, thereby assisting the operator in understanding the surrounding environment. When the clarity of the image data is reduced due to low light, high dust levels, or contamination of the camera lens, firstly, whether the engineering machine is currently in the moving state is determined based on the state data. When the engineering machine is in the moving state, the future movement route of the engineering machine is estimated. Then, the estimated movement route of the engineering machine and the average movement speed of the engineering machine at each position are obtained based on the movement trajectory of the other engineering machine, and the estimated movement route and the average movement speed are transmitted to the communication module. Finally, the difference value between the current movement speed of the engineering machine and the average movement speed of the engineering machine at the corresponding position on the estimated movement route is calculated, and the alarm information is generated when the difference value is greater than the first threshold value. In this way, the operator can be promptly alerted to potential risks ahead, enabling timely deceleration and reducing the likelihood of accidents, thereby enhancing the safety.

Further, at least four image collection modules are provided and distributed on four sides of the engineering machine.

The main control module is further configured to analyze the image data, identify an obstacle area in the image data, mark the obstacle area in the image data, and synthesize a panoramic image.

The display module is further configured to display the panoramic image.

It can assist the operator in understanding the surrounding environment of the engineering machine.

Further, the main control module is further configured to determine whether the difference value is greater than a second threshold value, and generate a deceleration control instruction when the difference value is greater than the second threshold value.

In this way, when the speed of the engineering machine is too high, it can enforce deceleration, thereby further enhancing the safety.

Further, the communication module is further configured to transmit type information of the engineering machine to the server.

The server is further configured to determine a starting point based on the current movement route of the engineering machine, and estimate the future movement route of the engineering machine based on the current movement route of the engineering machine and an existing movement route of another engineering machine of a same type and a same starting point.

Different types of engineering machine have different working tasks and usually travel different routes. The same type of engineering machine starts from different starting points and may perform different working tasks. For example, even though both are loading vehicles, those starting from different starting points typically transport different materials. In this preferred embodiment, by specifying the type and the starting point of the engineering machine, the accuracy of the estimated movement route can be improved.

Further, the display module is further configured to receive manual labeling information. The manual labeling information includes a labeling position and a labeling category.

The main control module is further configured to transmit the manual labeling information to the server.

The server is further configured to determine whether an engineering machine is within a predetermined range of a labeling position based on the received position data, and transmit the manual labeling information to a communication module of the engineering machine when the engineering machine is within the predetermined range of the labeling position.

The display module is further configured to obtain the manual labeling information from the communication module and display the manual labeling information.

For example, the display module may be selected as a display screen with touch function. The operator can directly mark an undisplayed obstacle on the image data displayed on the display screen to remind other operators to pay attention.

Further, when the main control module determines that the current position of the engineering machine is not on the estimated movement route, the main control module is further configured to transmit identification information to the server through the communication module.

The server is further configured to, subsequent to receiving the identification information, obtain the current position of the engineering machine, determine whether the current position is on the existing movement route of the other engineering machine, when the current position is on the existing movement route of other engineering machine, calculate an average movement speed of the other engineering machine at the position, and transmit the average movement speed of the other engineering machine at the position to the communication module; and the display module is further configured to obtain the average movement speed of the other engineering machine at the position from the communication module and display the average movement speed,
when the current position is not on the existing movement route of the other engineering machine, obtain an existing movement route of an engineering machine of a same type within a predetermined distance from the current position of the engineering machine, mark the existing movement route as a reference movement route, and transmit the reference movement route to the communication module.

The display module is further configured to obtain the reference movement route from the communication module and display the reference movement route.

By displaying the average movement speed of the other engineering machine, it can provide a reference for the operator and also facilitate the operator in estimating road conditions based on the average movement speed. By displaying the reference movement route, it is convenient for the operator to find the existing route.

Further, the server is further configured to determine whether the engineering machine generating the movement route is of a predetermined category, and when the engineering machine generating the movement route is of the predetermined category, match the movement route with the existing movement route of the other engineering machine, and mark a road section in the existing movement route of the other engineering machine that is coincident with the movement route as an invalid road section.

The server is further configured to exclude the invalid road section when matching the road sections of the estimated movement route of the engineering machine with the corresponding road sections of the existing movement route of the other engineering machine based on the estimated movement route.

Further, the communication module uses a 5G communication module.

The use of 5G communication results in lower latency.

### BRIEF DESCRIPTION OF THE DRAWINGS

FIG. 1 is a logical block diagram of an intelligent control system for an engineering machine according to Embodiment 1.

### DETAILED DESCRIPTION

The following describes in further detail with reference to the detailed description.

### Embodiment

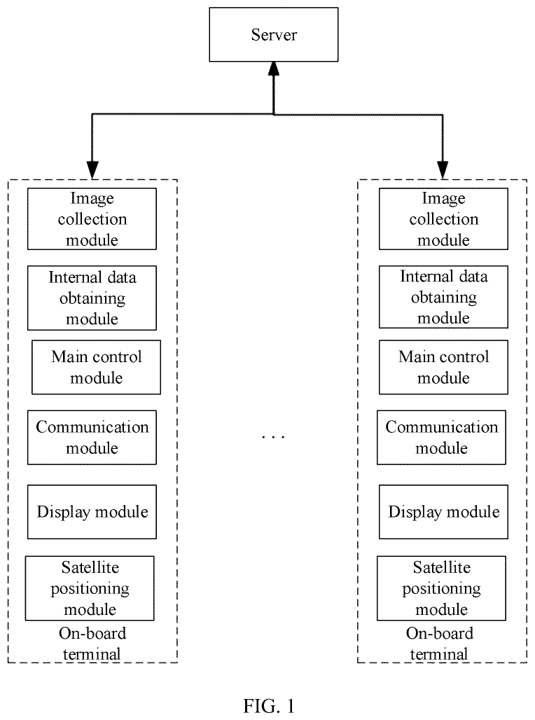

As shown in FIG. 1, an intelligent control system for an engineering machine according to the present embodiment includes a server and an on-board terminal disposed on the engineering machine.

The on-board terminal includes an image collection module, an internal data obtaining module, a satellite positioning module, a main control module, a communication module, and a display module

The satellite positioning module is configured to obtain current position data of the engineering machine.

The communication module is configured to transmit the position data to the server in real time. In the present embodiment, the communication module uses a 5G communication module.

The server is configured to generate a movement trajectory of each engineering machine based on the position data uploaded by each engineering machine. The movement trajectory includes a movement route of each engineering machine and a movement speed of each engineering machine at each position on the movement route.

The image collection module is configured to collect image data outside the engineering machine. At least four image collection modules are provided and distributed on four sides of the engineering machine, that is, the front side, the rear side, the left side, and the right side. In the present embodiment, four image collection modules are provided.

The internal data obtaining module is configured to obtain state data of the engineering machine. In the present embodiment, the state data includes a movement speed and a traveling direction.

The main control module is configured to analyze the image data, identify an obstacle area in the image data, mark the obstacle area in the image data, and synthesize a panoramic image. In the present embodiment, the image data is recognized through a pre-trained convolutional neural network (CNN) model. The obstacle area refers to an area that obstructs the passage of the engineering machine, or an area where there is a risk when the engineering machine passes through, such as areas with obstacles, ditches, walls, or mountains.

The main control module is configured to analyze the image data to determine whether clarity of the image data meets a predetermined requirement, when the predetermined requirement is not met, determine whether the engineering machine is currently in a moving state based on the state data, and when the engineering machine is currently in the moving state, transmit an auxiliary request to the server through the communication module. In the present embodiment, the moving state is defined as when the moving speed is greater than 0 and the direction of travel is towards the front of the vehicle. In other embodiments, both the forward direction towards the front of the vehicle and the backward direction towards the rear of the vehicle are considered as the moving states.

The communication module is further configured to transmit type information of the engineering machine to the server.

The server is further configured to, subsequent to receiving the auxiliary request, estimate a future movement route of the engineering machine based on a current movement route of the engineering machine and an existing movement route of another engineering machine. Specifically, the server determines a starting point based on the current movement route of the engineering machine, and estimates the future movement route of the engineering machine based on the current movement route of the engineering machine and an existing movement route of another engineering machine of a same type and a same starting point. In the present embodiment, the estimated movement route coincides with the existing movement route of the other engineering machine of the same type and the same starting point. That is, the engineering machine is estimated to travel along the movement route of the other engineering machine of the same type and the same starting point. When the other engineering machine of the same type and the same starting point has multiple different movement routes, each of the different routes are taken as the estimated movement route. With the continuous movement of the engineering machine, subsequent continuous calculations based on the latest movement route of the engineering machine can progressively eliminate the redundant routes.

The server is further configured to match road sections of the estimated movement route of the engineering machine with corresponding road sections of the existing movement route of the other engineering machine based on the estimated movement route, and calculate an average movement speed of the engineering machine at each position on a successfully matched road section as an average movement speed of the engineering machine at each position on the estimated movement route; and transmit the estimated movement route of the engineering machine and the average movement speed of the engineering machine at each position on the estimated movement route to the main control module through the communication module

The main control module is further configured to determine whether a current position of the engineering machine is on the estimated movement route, when the current position of the engineering machine is on the estimated movement route, calculate a difference value between a current movement speed of the engineering machine and an average movement speed of the engineering machine at a corresponding position on the estimated movement route, determine whether the difference value is greater than a first threshold value, and generate alarm information when the difference value is greater than the first threshold value. The main control module is further configured to determine whether the difference value is greater than a second threshold value, and generate a deceleration control instruction when the difference value is greater than the second threshold value. Subsequently, a braking mechanism of the engineering machine executes the deceleration control instruction to realize deceleration. The second threshold is greater than the first threshold. The first threshold value and the second threshold value are determined based on the type of the engineering machine and the environment of the construction site.

The display module is configured to display the panoramic image, and is further configured to, subsequent to receiving the alarm information, display the alarm information. The alarm information may be, for example, “The current speed is too high. Please decelerate.”

### Embodiment

The difference between the present embodiment and the first embodiment is that, in the present embodiment, the display module is further configured to receive manual labeling information. The manual labeling information includes a labeling position and a labeling category. The labeling category includes obstacle, people, deceleration, and other information used to alert other operators. For example, at a certain location where workers frequently pass by, the labeling category may be determined as “people”. The labeling category can be determined based on the actual situation of the construction site, facilitating direct selection by the operator and reducing input time.

The main control module is further configured to transmit the manual labeling information to the server.

The server is further configured to determine whether an engineering machine is within a predetermined range of a labeling position based on the received position data, and transmit the manual labeling information to a communication module of the engineering machine when the engineering machine is within the predetermined range of the labeling position.

The display module is further configured to obtain the manual labeling information from the communication module and display the manual labeling information.

### Embodiment

The difference between the present embodiment and the first embodiment is that, in the present embodiment, when the main control module determines that the current position of the engineering machine is not on the estimated movement route, the main control module is further configured to transmit identification information to the server through the communication module.

The server is further configured to, subsequent to receiving the identification information, obtain the current position of the engineering machine, determine whether the current position is on an existing movement route of another engineering machine, when the current position is on the existing movement route of other engineering machine, calculate an average movement speed of the other engineering machine at the position, and transmit the average movement speed of the other engineering machine at the position to the communication module; and the display module is further configured to obtain the average movement speed of the other engineering machine at the position from the communication module and display the average movement speed,
when the current position is not on the existing movement route of the other engineering machine, obtain an existing movement route of an engineering machine of a same type within a predetermined distance from the current position of the engineering machine, mark the existing movement route as a reference movement route, and transmit the reference movement route to the communication module.

The display module is further configured to obtain the reference movement route from the communication module and display the reference movement route.

### Embodiment

The difference between the present embodiment and the first embodiment is that, in the present embodiment, the server is further configured to determine whether the engineering machine generating the movement route is of a predetermined category, and when the engineering machine generating the movement route is of the predetermined category, match the movement route with the existing movement route of the other engineering machine, and mark a road section in the existing movement route of the other engineering machine that is coincident with the movement route as an invalid road section. The server is further configured to exclude the invalid road section when matching the road sections of the estimated movement route of the engineering machine with the corresponding road sections of the existing movement route of the other engineering machine based on the estimated movement route. In the present embodiment, the predetermined category is a road roller, a bulldozer, and the like. For the category of the engineering machine such as the roller or the bulldozer, the conditions of temporary roads is altered after they pass through, rendering the previous average movement speed no longer of reference value. By excluding the invalid road section, the accuracy of calculation for the average movement speed can be improved.

The above is only embodiments of the present disclosure, and the present disclosure is not limited to the field related to the embodiments, and common knowledge such as specific structures and characteristics known in the solution is not elaborated herein. Those skilled in the art know all the general technical knowledge in the technical field to which the present disclosure belongs before the filing date or the priority date, can obtain all the prior art in the field, and have the ability to apply conventional experimental means before the date. Those skilled in the art can, based on the teachings provided in the present disclosure, combine their own capabilities to complete and implement the solution. Commonly known structures or methods in the art should not constitute an obstacle for those skilled in the art to implement the present disclosure. It should be noted that, those skilled in the art can make various variants and improvements without departing from the concept of the present disclosure, and these variants and improvements shall fall within the protection scope of present disclosure as defined by the claims as attached, and will not affect the effect of the implementation of the present disclosure and the practicability of the patent. The protection scope of the present disclosure is defined by the claims as attached, and the description of the embodiments and the like in the specification can be used to explain the contents of the claims.

What is claimed is:

1. An intelligent control system for an engineering machine, the intelligent control system comprising a server and an on-board terminal disposed on the engineering machine, wherein the on-board terminal comprises an image collection module, an internal data obtaining module, a satellite positioning module, a main control module, a communication module, and a display module, wherein:
the satellite positioning module is configured to obtain current position data of the engineering machine;
the communication module is configured to transmit the position data to the server in real time;
the server is configured to generate a movement trajectory of each engineering machine based on the position data uploaded by each engineering machine, the movement trajectory comprising a movement route of each engineering machine and a movement speed of each engineering machine at each position on the movement route;
the image collection module is configured to collect image data outside the engineering machine;
the internal data obtaining module is configured to obtain state data of the engineering machine;
the main control module is configured to analyze the image data to determine whether clarity of the image data meets a predetermined requirement, when the predetermined requirement is not met, determine whether the engineering machine is currently in a moving state based on the state data, and when the engineering machine is currently in the moving state, transmit an auxiliary request to the server through the communication module;
the server is further configured to, subsequent to receiving the auxiliary request, estimate a future movement route of the engineering machine based on a current movement route of the engineering machine and an existing movement route of another engineering machine, match road sections of the estimated movement route of the engineering machine with corresponding road sections of the existing movement route of the other engineering machine based on the estimated movement route, and calculate an average movement speed of the engineering machine at each position on a successfully matched road section as an average movement speed of the engineering machine at each position on the estimated movement route; and transmit the estimated movement route of the engineering machine and the average movement speed of the engineering machine at each position on the estimated movement route to the main control module through the communication module;
the main control module is further configured to determine whether a current position of the engineering machine is on the estimated movement route, when the current position of the engineering machine is on the estimated movement route, calculate a difference value between a current movement speed of the engineering machine and an average movement speed of the engineering machine at a corresponding position on the estimated movement route, determine whether the difference value is greater than a first threshold value, and generate alarm information when the difference value is greater than the first threshold value; and
the display module is configured to display the image data and the alarm information.

2. The intelligent control system for the engineering machine according to claim 1, wherein at least four image collection modules are provided and distributed on four sides of the engineering machine;
the main control module is further configured to analyze the image data, identify an obstacle area in the image data, mark the obstacle area in the image data, and synthesize a panoramic image; and
the display module is further configured to display the panoramic image.

3. The intelligent control system for the engineering machine according to claim 1, wherein the main control module is further configured to determine whether the difference value is greater than a second threshold value, and generate a deceleration control instruction when the difference value is greater than the second threshold value.

4. The intelligent control system for the engineering machine according to claim 1, wherein the communication module is further configured to transmit type information of the engineering machine to the server; and
the server is further configured to determine a starting point based on the current movement route of the engineering machine, and estimate the future movement route of the engineering machine based on the current movement route of the engineering machine and an existing movement route of another engineering machine of a same type and a same starting point.

5. The intelligent control system for the engineering machine according to claim 4, wherein the display module is further configured to receive manual labeling information, the manual labeling information comprising a labeling position and a labeling category;
the main control module is further configured to transmit the manual labeling information to the server;
the server is further configured to determine whether an engineering machine is within a predetermined range of a labeling position based on the received position data, and transmit the manual labeling information to a communication module of the engineering machine when the engineering machine is within the predetermined range of the labeling position; and
the display module is further configured to obtain the manual labeling information from the communication module and display the manual labeling information.

6. The intelligent control system for the engineering machine according to claim 5, wherein when the main control module determines that the current position of the engineering machine is not on the estimated movement route, the main control module is further configured to transmit identification information to the server through the communication module;
the server is further configured to, subsequent to receiving the identification information, obtain the current position of the engineering machine, determine whether the current position is on the existing movement route of the other engineering machine, when the current position is on the existing movement route of other engineering machine, calculate an average movement speed of the other engineering machine at the position, and transmit the average movement speed of the other engineering machine at the position to the communication module; and the display module is further configured to obtain the average movement speed of the other engineering machine at the position from the communication module and display the average movement speed;
when the current position is not on the existing movement route of the other engineering machine, obtain an existing movement route of an engineering machine of a same type within a predetermined distance from the current position of the engineering machine, mark the existing movement route as a reference movement route, and transmit the reference movement route to the communication module; and
the display module is further configured to obtain the reference movement route from the communication module and display the reference movement route.

7. The intelligent control system for the engineering machine according to claim 6, wherein the server is further configured to determine whether the engineering machine generating the movement route is of a predetermined category, and when the engineering machine generating the movement route is of the predetermined category, match the movement route with the existing movement route of the other engineering machine, and mark a road section in the existing movement route of the other engineering machine that is coincident with the movement route as an invalid road section; and
the server is further configured to exclude the invalid road section when matching the road sections of the estimated movement route of the engineering machine with the corresponding road sections of the existing movement route of the other engineering machine based on the estimated movement route.

8. The intelligent control system for the engineering machine according to claim 1, wherein the communication module uses a 5G communication module.
